(19) United States
(12) Patent Application Publication
(10) Pub. No.: US 2026/0296296 A1
(43) Pub. Date: Oct. 1, 2026

(54) LIGHTING CIRCUIT AND VEHICLE LAMP

(71) Applicant: KOITO MANUFACTURING CO., LTD., Tokyo (JP)

(72) Inventors: Yuto TAKEKOSHI, Shizuoka (JP); Yonosuke HARA, Shizuoka (JP)

(73) Assignee: KOITO MANUFACTURING CO., LTD., Tokyo (JP)

(21) Appl. No.: 19/477,620

(22) PCT Filed: Mar. 25, 2024
(86) PCT No.: PCT/JP2024/011621

§ 371 Date: Oct. 22, 2025

(30) Foreign Application Priority Data
Apr. 24, 2023 (JP) 2023-071084

(51) Int. Cl. B60Q 1/00; B60Q 1/34; F21V 23/00

(52) U.S. Cl. CPC B60Q 1/0094; B60Q 1/34; F21V 23/003

(57) ABSTRACT

A lighting circuit configured to light a light source, the lighting circuit comprising: a first terminal configured to receive a first power supply voltage; a second terminal configured to receive a second power supply voltage; a power supply output circuit configured to output a first voltage corresponding to the first power supply voltage, regardless of whether the second power supply voltage is applied to the second terminal, when the first power supply voltage is applied to the first terminal, and output a second voltage corresponding to the second power supply voltage, when the second power supply voltage is applied to the second terminal without the first power supply voltage being applied to the first terminal; and a driver circuit configured to supply a first current to the light source, based on the first voltage, when the first voltage is outputted from the power supply output circuit, and supply a second current to the light source, based on the second voltage, when the second voltage is outputted from the power supply output circuit, wherein an input current used to detect a disconnection in the light source flows through the first terminal, when the first power supply voltage is applied to the first terminal.

### TECHNICAL FIELD

The present disclosure relates to a lighting circuit and a vehicle lamp.

### BACKGROUND ART

A plurality of light sources (high beam lamp, low beam lamp, daytime running lamp (DRL), clearance lamp, turn signal lamp, etc.) are provided, for example, to a vehicle according to applications and functions. Lighting circuits that light the light sources are also provided thereto corresponding to the plurality of light sources, respectively (for example, see FIG. 1, etc., of PTL 1).

### CITATION LIST

### Patent Literature

[PTL 1] Japanese Patent Application Publication No. 2022-171050

### SUMMARY OF INVENTION

### Technical Problem

It is possible to reduce costs if such a light source is configured as a multifunctional lamp that lights one light source with a plurality of functions (if the light source and lighting circuit are shared). However, depending on the type of light source, there have been cases where sharing was difficult. For example, a turn signal lamp can be lit even when the engine is off, and also has a feature that disconnection detection is performed based on the magnitude of the input current when lit, and thus it was needed to provide a light source and lighting circuit dedicated to the turn signal lamp.

The present disclosure is directed to provision of a lighting circuit that can reduce costs.

### Solution to Problem

A main aspect of the present disclosure is a lighting circuit configured to light a light source, the lighting circuit comprising: a first terminal configured to receive a first power supply voltage; a second terminal configured to receive a second power supply voltage; a power supply output circuit configured to output a first voltage corresponding to the first power supply voltage, regardless of whether the second power supply voltage is applied to the second terminal, when the first power supply voltage is applied to the first terminal, and output a second voltage corresponding to the second power supply voltage, when the second power supply voltage is applied to the second terminal without the first power supply voltage being applied to the first terminal; and a driver circuit configured to supply a first current to the light source, based on the first voltage, when the first voltage is outputted from the power supply output circuit, and supply a second current to the light source, based on the second voltage, when the second voltage is outputted from the power supply output circuit, wherein an input current used to detect a disconnection in the light source flows through the first terminal, when the first power supply voltage is applied to the first terminal.

### Advantageous Effects of Invention

According to the present disclosure, it is possible to provide a lighting circuit that can reduce costs.

### BRIEF DESCRIPTION OF DRAWINGS

FIG. 1 is a block diagram illustrating a configuration of a typical vehicular lamp 1A.

FIG. 2 is a diagram for explaining an operation of a vehicular lamp 1A.

FIG. 3 is a block diagram illustrating a configuration of a vehicular lamp 1 of an embodiment of the present disclosure.

FIG. 4 is a diagram illustrating an example of a configuration of a power supply output circuit 11.

FIG. 5 is a diagram illustrating an example of a configuration of a dimming circuit 13A.

FIG. 6 is a diagram for explaining an operation of a vehicular lamp 1.

FIGS. 7A to 7D are explanatory diagrams of a current flowing through a light source 20, respectively.

### DESCRIPTION OF EMBODIMENTS

### Cross-Reference to Related Applications

This application claims priority based on Japanese Patent Application No. 2023-071084, filed on Apr. 24, 2023, and incorporates the contents thereof by reference.

At least following matters will become apparent from the descriptions of the present specification and the accompanying drawings.

Hereinafter, preferred embodiments of the present disclosure will be described while referring to the drawings. Note that the same or equivalent constituent elements, members, and the like illustrated in the respective drawings are denoted by the same reference numerals, and redundant descriptions thereof are omitted as appropriate.

In an embodiment of the present disclosure, “connecting” refers to a state of being electrically connected, unless otherwise specified. For this reason, “connecting” also includes a case where two components are connected not only through wiring but also, for example, through a resistor.

### EMBODIMENT(S)

Before describing the vehicular lamp of an embodiment of the present disclosure, a configuration of a typical vehicular lamp will be described.

### Typical Vehicular Lamp 1A

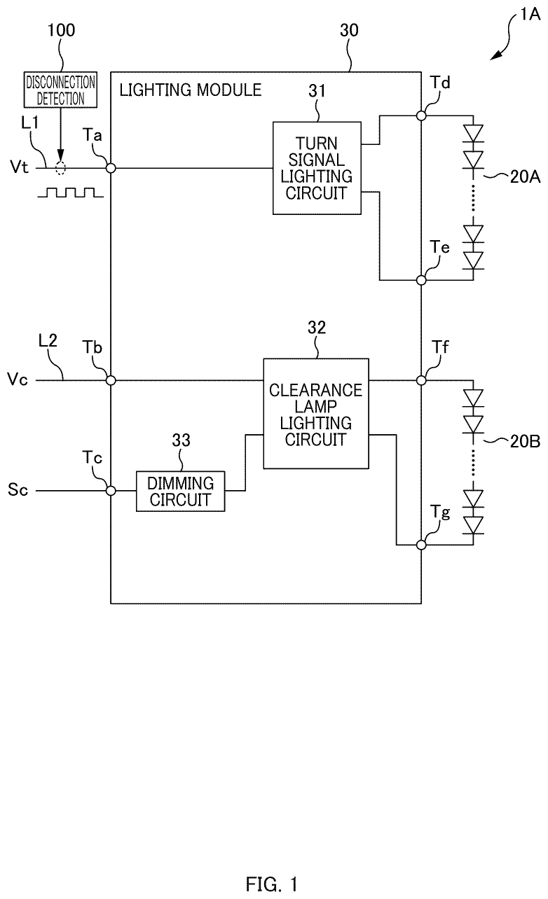

FIG. 1 is a block diagram illustrating a configuration of a typical vehicular lamp 1A.

The vehicular lamp 1A includes a light source 20A, a light source 20B, and a lighting module 30.

The light source 20A is a light source for a turn signal lamp (direction indicator light), and lights intermittently (blinks) based on a direction indicator being operated by a user of the vehicle (e.g., a driver). The light source 20A has a plurality of light-emitting elements (here, light-emitting diodes (LEDs)) connected in series, and is connected between a terminal Td and a terminal Te of the lighting module 30. Note that the terminal Te is grounded, and the light source 20A is lit by being supplied with a drive current from a turn signal lighting circuit 31, which will be described later, through the terminal Td.

The light source 20B is a light source for a clearance lamp (side marker lamp) for informing the surroundings of the vehicle width and presence, and is used, for example, when it is twilight outside the vehicle. Note that clearance lamps are often provided at positions close to turn signal lamps, and may be provided to the same housing. A clearance lamp is also called, for example, a “small lamp” or a “position lamp.” The light source 20B has a plurality of light-emitting elements (here, light-emitting diodes (LEDs)) connected in series, and is connected between a terminal Tf and a terminal Tg of the lighting module 30. Note that the terminal Tg is grounded, and the light source 20B is lit by being supplied with a drive current from a clearance lamp lighting circuit 32, which will be described later, through the terminal Tf.

The lighting module 30 is a module for controlling the light source 20A and the light source 20B, and includes the turn signal lighting circuit 31, the clearance lamp lighting circuit 32, a dimming circuit 33, and terminals Ta to Tc and the terminals Td to Tg.

The turn signal lighting circuit 31 turns on or off the light source 20A based on a turn signal power supply voltage Vt applied to the terminal Ta through a power supply line L1. Note that a switch (not illustrated) such as a mechanical contact relay or a non-contact relay using a semiconductor device is provided between the power supply line L1 and a vehicle battery.

The above switch is controlled to be turned on and off at a predetermined period, based on the driver of the vehicle operating a direction indicator or a hazard button. When the switch is turned on, a voltage of the battery (e.g., 12 V) is applied to the power supply line L1. On the other hand, when the switch is turned off, the voltage of the battery is no longer applied to the power supply line L1. As a result, due to the influence of resistors, circuits, and the like of the lighting module 30 that are not illustrated, the voltage of the power supply line L1 drops to zero.

Thus, the turn signal power supply voltage Vt results in a pulsed (rectangular) voltage in which a high level (hereinafter, referred to as high or high level) and a low level (hereinafter, referred to as low or low level) are alternately repeated at a predetermined period. In the following description, the turn signal power supply voltage Vt is also referred to as a turn voltage Vt. The turn voltage Vt is applied to the terminal Ta by the turning on and off of the switch, regardless of the state of the engine of the vehicle.

The clearance lamp lighting circuit 32 lights (specifically, dimly lights as will be described later) or turns off the light source 20B based on a clearance lamp power supply voltage Vc applied to the terminal Tb through a power supply line L2 and an output signal of the dimming circuit 33. Note that an ignition switch (not illustrated) is provided between the power supply line L2 and the vehicle battery, and when the engine of the vehicle is turned on, the voltage of the battery (e.g., 12 V) is applied to the power supply line L2. On the other hand, when the engine of the vehicle is stopped (turned off), the voltage of the power supply line L2 drops to zero. That is, the clearance lamp power supply voltage Vc goes high when the engine of the vehicle is on (ON), and goes low when the engine is off (OFF). In the following description, the clearance lamp power supply voltage Vc is also referred to as a CLL voltage Vc. As described above, both the turn voltage Vt and the CLL voltage Vc are supplied from the vehicle battery.

A clearance lamp lighting instruction signal Sc applied to the terminal Tc is a signal outputted by an ECU (not illustrated), and, for example, is low when the clearance lamp is OFF (light source 20B is off) and is high when the clearance lamp is ON (light source 20B is lit). Switching between low and high of the clearance lamp lighting instruction signal Sc may be manual (e.g., by an operation by the driver) or automatic (e.g., automatically switching according to the brightness outside the vehicle).

The dimming circuit 33 outputs a signal to light the light source 20B to the clearance lamp lighting circuit 32 in response to the clearance lamp lighting instruction signal Sc. Specifically, when the clearance lamp lighting instruction signal Sc is high, the dimming circuit 33 outputs a signal having a predetermined duty cycle (e.g., a duty cycle of 15%) to the clearance lamp lighting circuit 32. When the CLL voltage Vc is high, the clearance lamp lighting circuit 32 dimly lights the light source 20B according to the duty cycle of the signal from the dimming circuit 33. On the other hand, when the clearance lamp lighting instruction signal Sc is low, the dimming circuit 33 causes the duty cycle of the output signal to be low (0%). This causes the clearance lamp lighting circuit 32 to turn off the light source 20B even if the CLL voltage Vc is high.

### Regarding Disconnection Detection

As illustrated in FIG. 1, a vehicle in which the light source 20A (turn signal lamp) is incorporated is provided with a disconnection detection device 100 so that a current (input current) flowing from the vehicle side (specifically, the battery) to the terminal Ta can be monitored. The disconnection detection device 100 monitors the input current when the light source 20A is being driven, and when the current value of the input current is smaller than a predetermined threshold value, detects that there is a disconnection in any of the plurality of light-emitting elements (LEDs) of the light source 20A.

When the disconnection detection device 100 detects (senses) a disconnection, it notifies the ECU of the vehicle or the like to that effect. Based on this, a display or the like is performed on the vehicle side, which makes it possible to inform the driver of the vehicle of the occurrence of an abnormality (disconnection).

### Operation of Vehicular Lamp 1A

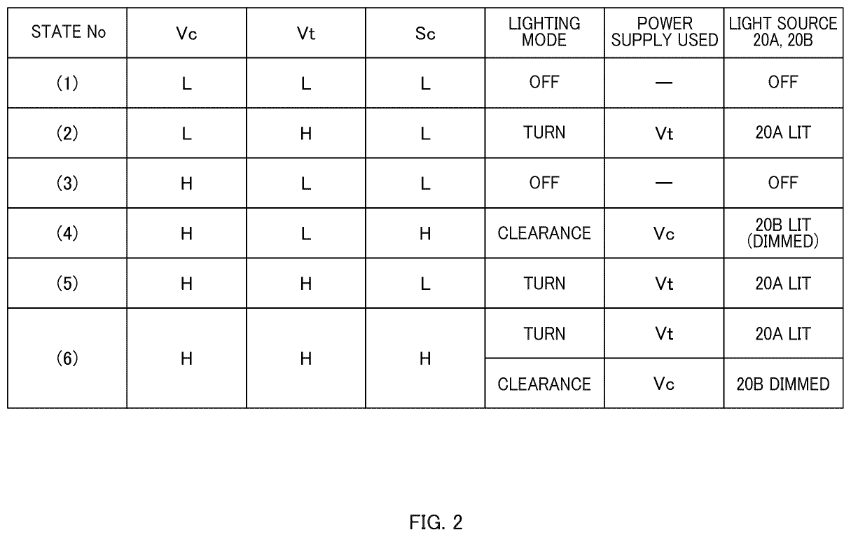

FIG. 2 is a diagram for explaining an operation of the vehicular lamp 1A. The operation of the vehicular lamp 1A will be described with reference to FIGS. 1 and 2.

### Engine OFF, Clearance Lamp Off (OFF), Turn Signal Blinking (ON, OFF)

The light source 20A is provided so as to blink even when the engine is OFF, for example, in the case of a hazard. When the light source 20A is caused to blink (ON, OFF) with the engine OFF (and the clearance lamp also OFF), turning on and off of the light source 20A are alternately repeated in the state No. (1) and the state No. (2) of FIG. 2. Specifically, due to the engine being OFF, the CLL voltage Vc is low. In addition, due to the clearance lamp being OFF, the clearance lamp lighting instruction signal Sc is low. As a result, the clearance lamp lighting circuit 32 turns off the light source 20B. The turn signal lighting circuit 31 lights the light source 20A based on the turn voltage Vt during a time period during which the turn voltage Vt is high (state No. (2)), and causes the light source 20A to be off during a time period during which the turn voltage Vt is low (state No. (1)).

### Engine ON, Clearance Lamp Lit (ON), Turn Signal Off (OFF)

When the light source 20B for the clearance lamp is to be lit, the engine is in an ON state, and the CLL voltage Vc applied to the terminal Tb is high. As described above, when the light source 20B is to be lit, the clearance lamp lighting instruction signal Sc goes high. Since the clearance lamp lighting instruction signal Sc is high, the dimming circuit 33 outputs a signal with a predetermined duty cycle (e.g., 15%). Further, due to the turn signal being OFF, the voltage (turn voltage Vt) applied to the terminal Ta is low.

In this case, since the turn voltage Vt is low, the turn signal lighting circuit 31 turns off the light source 20A. The clearance lamp lighting circuit 32 lights (dimly light) the light source 20B based on the CLL voltage Vc and the signal from the dimming circuit 33 (15% duty cycle) (state No. (4)).

### Engine ON, Clearance Lamp Off (OFF), Turn Signal Blinking (ON, OFF)

When only the light source 20A is to be lit (blinking) in a state where the engine is ON (CLL voltage Vc is high), the clearance lamp lighting instruction signal Sc is low. Since the clearance lamp lighting instruction signal Sc is low, the clearance lamp lighting circuit 32 turns off the light source 20B. The turn signal lighting circuit 31 lights the light source 20A based on the turn voltage Vt during a time period during which the turn voltage Vt is high (state No. (5)), and causes the light source 20A to be off during a time period during which the turn voltage Vt is low (state No. (3)).

### Engine ON, Clearance Lamp Lit (ON), Turn Signal Blinking (ON, OFF)

When both the light source 20A and the light source 20B are to be lit in a state where the engine is ON (CLL voltage Vc is high), the clearance lamp lighting instruction signal Sc goes high, and the dimming circuit 33 outputs a signal with a predetermined duty cycle (e.g., 15%).

During a time period during which the turn voltage Vt is high, the turn signal lighting circuit 31 lights the light source 20A based on the turn voltage Vt, and the clearance lamp lighting circuit 32 dimly lights the light source 20B based on the CLL voltage Vc and the signal from the dimming circuit 33 (15% duty cycle) (state No. (6)).

During a time period during which the turn voltage Vt is low, the turn signal lighting circuit 31 causes the light source 20A to be off, and the clearance lamp lighting circuit 32 dimly lights the light source 20B based on the CLL voltage Vc and the signal from the dimming circuit 33 (15% duty cycle) (state No. (4)).

As described above, when the light source 20A is to be lit (when the turn voltage Vt is high), the disconnection detection device 100 performs disconnection detection based on the input current flowing from the vehicle side (outside of the vehicular lamp 1A) to the power supply line L1 (in other words, the terminal Ta).

As described above, the light source 20A is configured to light (blink) even when the engine is OFF, for example, in the case of a hazard.

Since the turn signal lamp has such a unique function, lighting circuits (the turn signal lighting circuit 31, the clearance lamp lighting circuit 32) and light sources (the light source 20A, 20B) need to be provided for the turn signal use and the clearance use, respectively, which incurred costs.

Thus, in an embodiment of the present disclosure, the light source and the lighting circuit are shared between the turn signal use and the clearance use, while having such a function as described above. This achieves a reduction in costs.

### Vehicular Lamp 1 of Embodiment of Present Disclosure

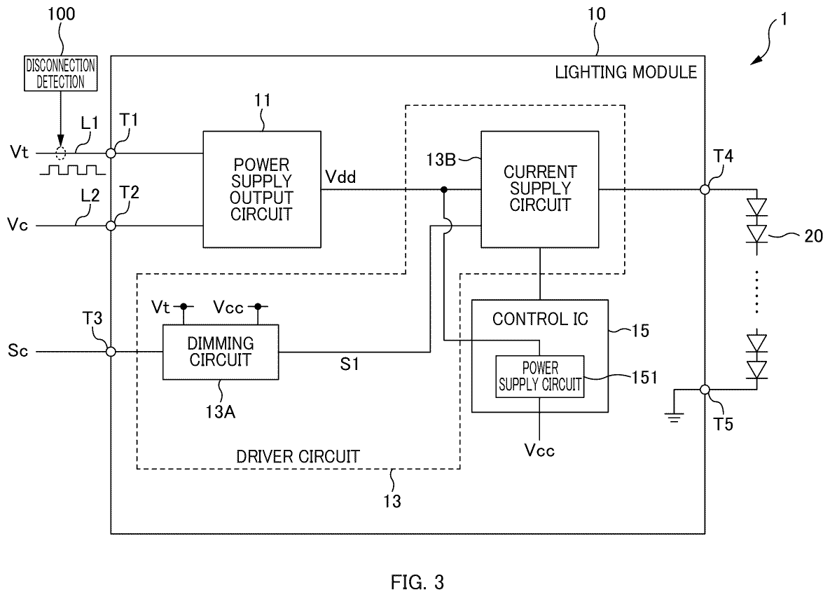

FIG. 3 is a block diagram illustrating a configuration of a vehicular lamp 1 of an embodiment of the present disclosure. The vehicular lamp 1 of an embodiment of the present disclosure includes a lighting module 10 and a light source 20.

The lighting module 10 lights the light source 20 as a turn signal lamp and a clearance lamp. The lighting module 10 is a module in which a plurality of circuits to light the light source 20, and terminals T1 to T5, are mounted to a substrate, and the lighting module 10 will be described later in detail. In an embodiment of the present disclosure, the lighting module 10 corresponds to a “lighting circuit.”

The light source 20 is a photoelectric element used as a turn signal lamp and a clearance lamp. The light source 20 has a plurality of light-emitting elements (here, light-emitting diodes (LEDs)) connected in series, and is connected between the terminal T4 and the terminal T5 of the lighting circuit 10. Note that the terminal T5 is grounded, and the light source 20 is lit by being supplied with a drive current from the lighting circuit 10 through the terminal T4.

### Configuration of Lighting Module 10

The lighting module 10 includes a power supply output circuit 11, a driver circuit 13, a control IC 15, and the terminals T1 to T5, as illustrated in FIG. 3. Note that the terminals T1 to T3 correspond to the terminals Ta to Tc of FIG. 1, respectively. That is, the terminal T1 is connected to the power supply line L1, and the pulsed turn voltage Vt is applied thereto. The terminal T2 is connected to the power supply line L2, and the CLL voltage Vc is applied thereto. The clearance lamp lighting instruction signal Sc is applied to the terminal T3. In an embodiment of the present disclosure, the turn voltage Vt corresponds to a “first power supply voltage,” and the terminal T1 corresponds to a “first terminal.” The CLL voltage Vc corresponds to a “second power supply voltage,” and the terminal T2 corresponds to a “second terminal.”

The power supply output circuit 11 is a circuit that switches a voltage to be outputted to the driver circuit 13 in a subsequent stage, based on the turn voltage Vt applied to the terminal T1 and the CLL voltage Vc applied to the terminal T2. Details of the power supply output circuit 11 will be described later.

The driver circuit 13 supplies a drive current to the light source 20 based on an output voltage Vdd of the power supply output circuit 11 and the clearance lamp lighting instruction signal Sc, and lights the light source 20 (the plurality of light-emitting elements) at appropriate timing and brightness. The driver circuit 13 of an embodiment of the present disclosure includes a dimming circuit 13A and a current supply circuit 13B.

The dimming circuit 13A outputs a signal S1 having a duty cycle based on a state (lighting state) of the light source 20, according to the turn voltage Vt and the clearance lamp lighting instruction signal Sc. The signal S1 corresponds to a “signal”. Details of the dimming circuit 13A will be described later.

The current supply circuit 13B generates a drive current corresponding to the duty cycle of the signal S1 outputted from the dimming circuit 13A, while generating a power supply voltage to drive the light source 20, based on the output voltage Vdd of the power supply output circuit 11, and supplies the drive current to the light source 20 through the terminal T4. Note that the above drive current corresponds to a “current that increases with an increase in the duty cycle”, is at a minimum (zero) when the duty cycle is zero percent (low), and is at a maximum (a drive current I1, which will be described later) when the duty cycle is 100% (high).

The power supply voltage generated in the current supply circuit 13B is a voltage needed to light the light source 20 (the plurality of light-emitting elements connected in series). For example, when the number of light-emitting elements (LEDs) of the light source 20 is four, and the voltage needed to cause one light-emitting element to emit light is 3 V, then 12 V is needed to cause all of them to emit light. Since the voltage of the vehicle battery in an embodiment of the present disclosure is, for example, 12 V, the output voltage Vdd of the power supply output circuit 11 is boosted to a sufficiently high voltage (e.g., about 15 V). However, the present disclosure is not limited thereto; for example, if the number of light-emitting elements is small, the output voltage Vdd of the power supply output circuit 11 may be stepped down.

The control IC 15 is an integrated circuit that controls the operation of the lighting module 10, and here, it controls the operation of the current supply circuit 13B of the driver circuit 13. Further, the control IC 15 includes a power supply circuit 151. The power supply circuit 151 generates a predetermined power supply voltage Vcc (e.g., 7 V) based on the output voltage Vdd of the power supply output circuit 11.

### Configuration of Power Supply Output Circuit 11

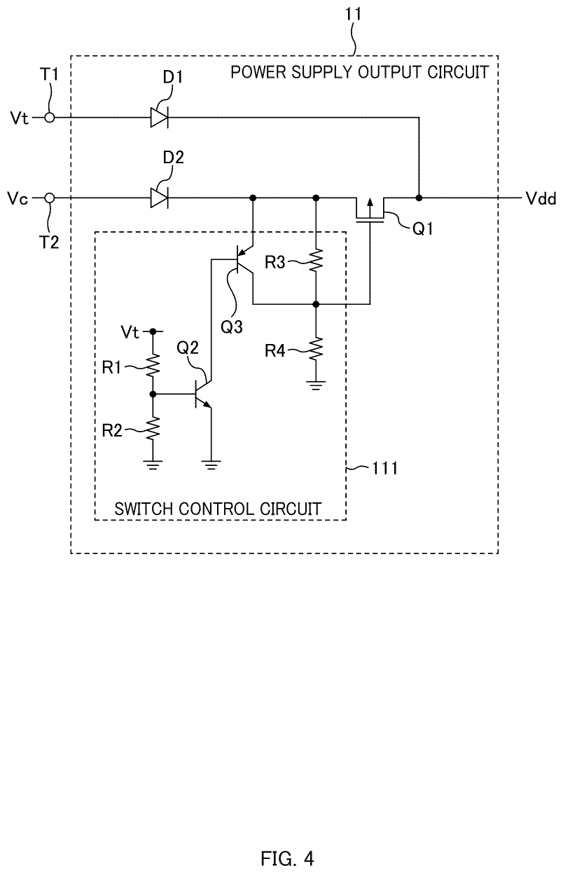

FIG. 4 is a diagram illustrating an example of a configuration of the power supply output circuit 11. The power supply output circuit 11 illustrated in FIG. 4 includes diodes D1 and D2, a PMOS transistor Q1, and a switch control circuit 111.

The diode D1 and the diode D2 are diodes for reverse current protection. The diode D1 has an anode connected to the terminal T1, and a cathode connected to the drain of the PMOS transistor Q1. The diode D1 corresponds to a “first diode.” The diode D2 has an anode connected to the terminal T2, and a cathode connected to the source of the PMOS transistor Q1. The diode D2 corresponds to a “second diode”.

The PMOS transistor Q1 is connected between the cathode of the diode D1 and the cathode of the diode D2. The gate of the PMOS transistor Q1 is connected to the switch control circuit 111. The PMOS transistor Q1 corresponds to a “switch.”

The switch control circuit 111 is a circuit that controls on/off of the PMOS transistor Q1, and includes resistors R1 to R4, an NPN transistor Q2, and a PNP transistor Q3.

The resistor R1 and the resistor R2 are connected in series, the turn voltage Vt is applied to the resistor R1, and the resistor R2 is grounded.

The base of the NPN transistor Q2 is connected to a connecting point between the resistor R1 and the resistor R2. The collector of the NPN transistor Q2 is connected to the base of the PNP transistor Q3, and the emitter of the NPN transistor Q2 is grounded.

The resistor R3 and the resistor R4 are connected in series between the cathode of the diode D2 and the ground.

The emitter of the PNP transistor Q3 is connected to the cathode of the diode D2. The collector of the PNP transistor Q3 is connected to a connection between the resistor R3 and the resistor R4, and is also connected to the gate of the PMOS transistor Q1.

Next, the operation of the switch control circuit 111 will be described.

### When Turn Voltage Vt is High

When the turn voltage Vt is high, the NPN transistor Q2 of the switch control circuit 111 is on. With the NPN transistor Q2 being on, the PNP transistor Q3 is on. This causes the gate and source of the PMOS transistor Q1 to be at the same potential, and thus the PMOS transistor Q1 is turned off. That is, regardless of the value (high, low) of the CLL voltage Vc, the PMOS transistor Q1 is turned off. In other words, when the turn voltage Vt is applied to the terminal T1, the switch control circuit 111 controls the PMOS transistor Q1 so as to be off so that a voltage corresponding to the turn voltage Vt (specifically, a voltage dropped due to the forward voltage drop of the diode D1 (e.g., 0.7 V)) is outputted from the power supply output circuit 11. In this event, the diode D2 prevents a current from flowing to the terminal T2 (reverse current to the vehicle side) through a parasitic diode of the PMOS transistor Q1. Note that the output voltage Vdd of the power supply output circuit 11 in this event (the voltage corresponding to the turn voltage Vt) corresponds to a “first voltage.”

### When Turn Voltage Vt is Low and CLL Voltage Vc is High

When the turn voltage Vt is low, the NPN transistor Q2 of the switch control circuit 111 is turned off. With the NPN transistor being off, the PNP transistor Q3 is off as well. Thus, a voltage corresponding to the CLL voltage Vc (specifically, a voltage dropped due to the forward voltage drop of the diode D2 (e.g., 0.7 V)) is divided by the resistor R3 and the resistor R4, and that divided voltage is applied to the gate of the PMOS transistor Q1. This causes the gate-source voltage of the PMOS transistor Q1 to exceed a threshold value, thereby turning on the PMOS transistor Q1. Thus, a voltage corresponding to the CLL voltage Vc (a voltage through the diode D2 and the PMOS transistor Q1) is outputted from the power supply output circuit 11. In other words, when the CLL voltage Vc is applied to the terminal T2 without the turn voltage Vt being applied to the terminal T1, the switch control circuit 111 controls the PMOS transistor Q1 so as to be on so that a voltage corresponding to the CLL voltage Vc is outputted from the power supply output circuit 11. In this event, the diode D1 prevents a current from flowing to the terminal T1 (reverse current to the vehicle side). Note that the output voltage Vdd of the power supply output circuit 11 in this event (the voltage corresponding to the CLL voltage Vc) corresponds to a “second voltage.”

When both the turn voltage Vt and the CLL voltage Vc are low, all of the NPN transistor Q2, the PNP transistor Q3, and the PMOS transistor Q1 are off, and the output voltage Vdd of the power supply output circuit 11 results in being low as well.

As described above, when the turn voltage Vt is high, the power supply output circuit 11 outputs a voltage corresponding to the turn voltage Vt regardless of the CLL voltage Vc, and when the turn voltage Vt is low and the CLL voltage Vc is high, the power supply output circuit 11 outputs a voltage corresponding to the CLL voltage Vc.

### Configuration of Dimming Circuit 13A

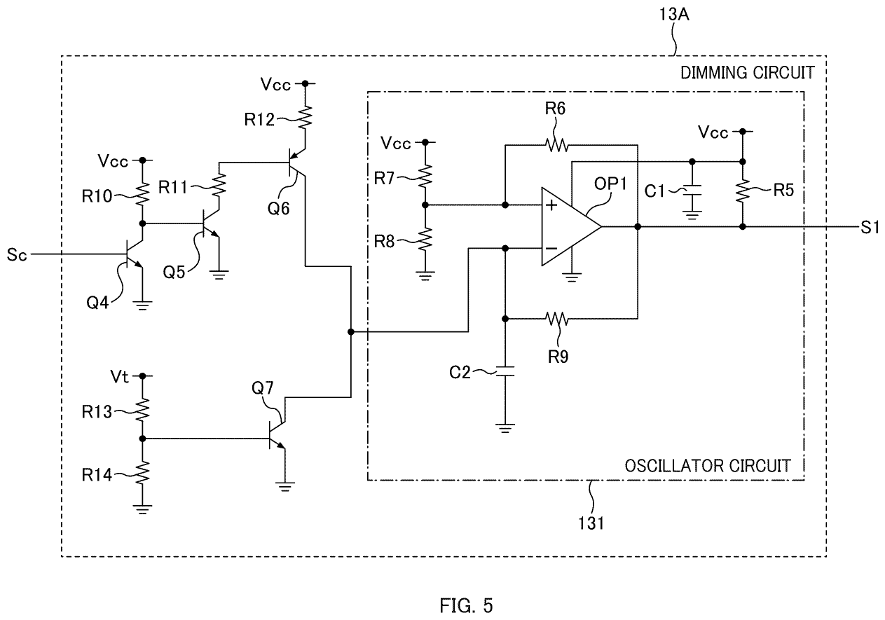

FIG. 5 is a diagram illustrating an example of a configuration of the dimming circuit 13A. The dimming circuit 13A includes an oscillator circuit 131, resistors R10 to R14, NPN transistors Q4, Q5, and Q7, and a PNP transistor Q6.

First, the configuration and operation of the oscillator circuit 131 will be described. The oscillator circuit 131 is a typical oscillator circuit including an operational amplifier OP1 and a capacitor C2, and includes the operational amplifier OP1, a capacitor C1 and the capacitor C2, and resistors R5 to R9.

The capacitor C1 is a capacitor provided to hold the operation of the operational amplifier OP1 during a time period during which the power supply voltage Vcc is not supplied, and is connected between a supply line to supply the power supply voltage Vcc to the operational amplifier OP1 and the ground.

The resistor R5 is a resistor to pull up the output of the operational amplifier OP1, has one end to receive the power supply voltage Vcc, and the other end connected to the output of the operational amplifier OP1.

The capacitor C2 is connected between an inverting input terminal (-terminal) of the operational amplifier OP1 and the ground. The-terminal of the operational amplifier OP1 is connected through the resistor R9 to the output of the operational amplifier OP1.

A non-inverting input terminal (+terminal) of the operational amplifier OP1 is connected to a connecting point between the resistor R7 and the resistor R8 that are connected in series, and is also connected through the resistor R6 to the output of the operational amplifier OP1. The power supply voltage Vcc is applied to the resistor R7, and the resistor R8 is grounded. In an embodiment of the present disclosure, the resistance values of the resistors R6, R7, and R8 are all the same.

The operational amplifier OP1 outputs a high level (the power supply voltage Vcc), when the voltage at the +terminal thereof is higher than the voltage at the −terminal thereof, and outputs a low level (ground voltage), when the voltage at the +terminal thereof is lower than the voltage at the −terminal thereof. In an embodiment of the present disclosure, the operational amplifier OP1 is used, but the present disclosure is not limited thereto; for example, a comparator may be used.

### When Voltage at +Terminal of Operational Amplifier Op1 Is Higher Than Voltage at −Terminal Thereof

In this case, the output of the operational amplifier OP1 goes high (the power supply voltage Vcc) as described above, and thus the resistor R6 enters a state of being connected in parallel with the resistor R7. That is, the voltage at the +terminal of the operational amplifier OP1 exceeds the divided voltage of the power supply voltage Vcc obtained by only the resistor R7 and resistor R8. Here, since the resistance values of the resistors R6, R7, and R8 are all the same, the voltage at the +terminal of the operational amplifier OP1 results in ⅔ Vcc (about 4.6 V when Vcc is 7 V).

The capacitor C1 is charged since the output of the operational amplifier OP1 (the power supply voltage Vcc) is applied thereto through the resistor R9. Thus, the voltage at the-terminal of the operational amplifier OP1 rises. The capacitor C1 is charged until it reaches the voltage at the +terminal of the operational amplifier OP1 (4.6 V in this case), and in response to it reaching the voltage at the +terminal of the operational amplifier OP1, the output of the operational amplifier OP1 switches (goes low).

### When Voltage at +Terminal of Operational Amplifier OP1 is Lower than Voltage at −Terminal Thereof

In this case, the output of the operational amplifier OP1 goes low (ground voltage) as described above, and thus the resistor R6 enters a state of being connected in parallel with the resistor R8. That is, the voltage at the +terminal of the operational amplifier OP1 drops below the divided voltage of the power supply voltage Vcc obtained by only the resistor R7 and resistor R8. Here, since the resistance values of the resistors R6, R7, and R8 are all the same, the voltage at the +terminal of the operational amplifier OP1 results in ⅓ Vcc (about 2.3 V when Vcc is 7 V).

The capacitor C1 is discharged through the resistor R9 since the output of the operational amplifier OP1 is low (ground level). Thus, the voltage at the −terminal of the operational amplifier OP1 drops. The capacitor C1 is discharged until it reaches the voltage at the +terminal of the operational amplifier OP1 (2.3 V in this case), and in response to it reaching the voltage at the +terminal of the operational amplifier OP1, the output of the operational amplifier OP1 switches (goes high).

In this way, charging the capacitor C2 to a high threshold value (4.6 V) and discharging it to a low threshold value (2.3 V) are alternately and repeatedly performed. During the time period during which the capacitor C2 is being charged, the output (signal S1) of the oscillator circuit 131 is high, and during the time period during which the capacitor C2 is being discharged, the output (signal S1) of the oscillator circuit 131 is low. The signal S1 outputted from the oscillator circuit 131 becomes a signal having a predetermined duty cycle (e.g., 15%) due to the settings of the capacity values of the capacitor C2 and the resistors.

Next, the configuration of a part of the dimming circuit 13A other than the oscillator circuit 131 will be described.

The clearance lamp lighting instruction signal Sc is applied to the base of the NPN transistor Q4, and the power supply voltage Vcc is applied to the collector thereof through a resistor R10. The emitter of the NPN transistor Q4 is grounded.

The base of the NPN transistor Q5 is connected to the collector of the NPN transistor Q4. The collector of the NPN transistor Q5 is connected through the resistor R11 to the base of the PNP transistor Q6, and the emitter of the NPN transistor Q5 is grounded.

The power supply voltage Vcc is applied to the emitter of the PNP transistor Q6 through the resistor R12. The collector of the PNP transistor Q6 is connected to the −terminal of the operational amplifier OP1 of the oscillator circuit 131 (and the capacitor C2).

The resistor R13 and the resistor R14 are connected in series, the turn voltage Vt is applied to the resistor R13, and the resistor R14 is grounded. The base of the NPN transistor Q7 is connected to a connecting point between the resistor R13 and the resistor R14. The resistance values of the resistor R13 and the resistor R14 are set such that the NPN transistor Q7 is on when the turn voltage Vt is high, and the NPN transistor Q7 is off when the turn voltage Vt is low.

The collector of the NPN transistor Q7 is connected to the −terminal of the operational amplifier OP1 of the oscillator circuit 131 (and the capacitor C2), and the emitter of the NPN transistor Q7 is grounded.

### Operation of Dimming Circuit 13A

Next, the operation of the dimming circuit 13A will be described.

### When Turn Voltage Vt is High

When the turn voltage Vt is high, the NPN transistor Q7 is on. With the NPN transistor Q7 being on, the charge stored in the capacitor C2 of the oscillator circuit 131 is discharged (the capacitor C2 is discharged).

As a result, the voltage at the-terminal of the operational amplifier OP1 drops below the voltage at the +terminal, and the output (signal S1) of the dimming circuit 13A goes high (has a duty cycle of 100%). In this case, the lighting module 10 (the current supply circuit 13B) lights the light source 20 based on the turn voltage Vt. Note that a state when the light source 20 is lit based on the turn voltage Vt (states No. (2), (5), and (6), which will be described later) corresponds to a “first state,” and the duty cycle (100%) of the signal S1 in this state corresponds to a “first duty cycle.”

### When Turn Voltage Vt is Low and Clearance Lamp Lighting Instruction Signal Sc is High

When the turn voltage Vt is low, the NPN transistor Q7 is off. With the clearance lamp lighting instruction signal Sc being high, the NPN transistor Q4 is on, and the NPN transistor Q5 is off since a current is not supplied to the base thereof. As a result, the PNP transistor Q6 is turned off as well.

Thus, the output (signal S1) of the dimming circuit 13A results in a signal having a duty cycle (e.g., 15%) set by the oscillator circuit 131. In this case, the lighting module 10 (the current supply circuit 13B) lights the light source 20 based on the CLL voltage Vc. Note that a state when the light source 20 is lit based on the CLL voltage Vc (state No. (4), which will be described later) corresponds to a “third state,” and the duty cycle (15%) of the signal S1 in this state corresponds to a “second duty cycle.

### When Turn Voltage Vt Is Low and Clearance Lamp Lighting Instruction Signal Sc Is Low

When the turn voltage Vt is low, the NPN transistor Q7 is off as described above. With the clearance lamp lighting instruction signal Sc being low, the NPN transistor Q4 is off, and a current is supplied to the base of the NPN transistor Q5 from the power supply voltage Vcc through the resistor R10, and thus the NPN transistor Q5 is turned on. With the NPN transistor Q5 being turned on, the PNP transistor Q6 is turned on, and a current flows from the power supply voltage Vcc to the capacitor C2 of the oscillator circuit 131 through the resistor R12 and the PNP transistor Q6, and the capacitor C2 is charged.

This causes the voltage at the-terminal of the operational amplifier OP1 to exceed the voltage at the +terminal, and the output (signal S1) of the dimming circuit 13A goes low (has a duty cycle of zero percent). Since the duty cycle reaches zero, the lighting module 10 (the current supply circuit 13B) turns off the light source 20. The state in this event (states No. (1) and (3), which will be described later) correspond to a “second state”.

### Operation of Vehicular Lamp 1

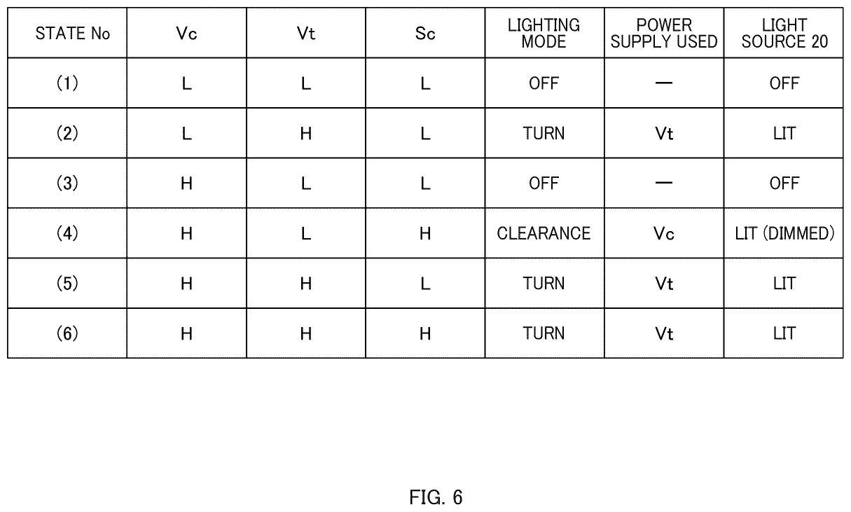

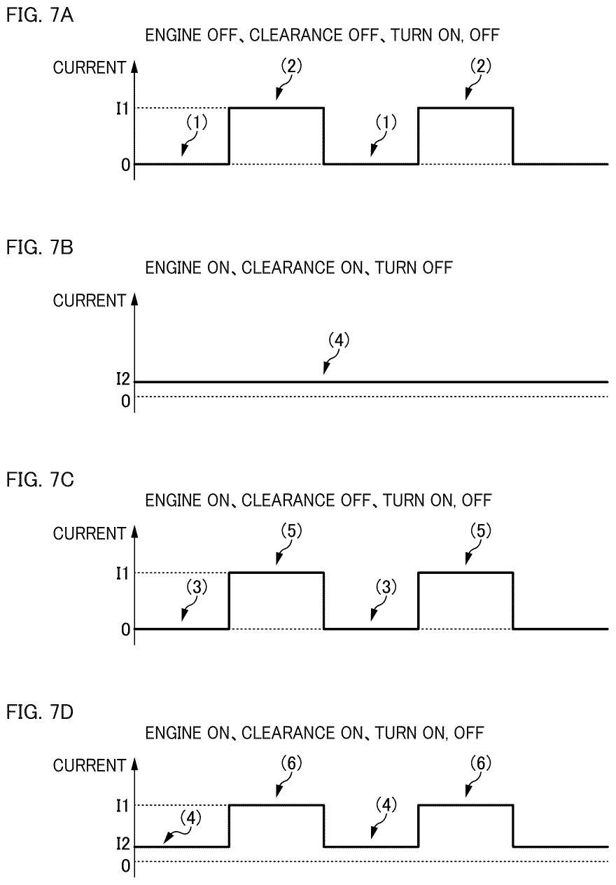

FIG. 6 is a diagram for explaining an operation of the vehicular lamp 1 of an embodiment of the present disclosure. FIGS. 7A to 7D are explanatory diagrams of a current flowing through the light source 20. The vertical axes of FIGS. 7A to 7D represent the current value flowing through the light source 20, and the horizontal axes represent time.

The following describes the operation of the vehicular lamp 1 with reference to the drawings (FIGS. 3 to 6, and FIGS. 7A to 7D).

### Engine OFF, Clearance Lamp Off (OFF), Turn Signal Blinking (ON, OFF)

As described above, in this case, the CLL voltage Vc is low, the clearance lamp lighting instruction signal Sc is low, and the turn voltage Vt alternately repeats high and low at a predetermined period.

When the turn voltage Vt is high, the output voltage Vdd of the power supply output circuit 11 of FIG. 4 becomes a voltage corresponding to the turn voltage Vt. The signal S1 outputted from the dimming circuit 13A of FIG. 5 goes high (has a duty cycle of 100%). The current supply circuit 13B of FIG. 3 supplies the drive current 11 to the light source 20 based on the output voltage Vdd of the power supply output circuit 11 and the signal S1, and lights it as a turn signal lamp (state No. (2) in FIG. 6 and FIG. 7A). This drive current 11 corresponds to a “first current.”

When the turn voltage Vt is low, the CLL voltage Vc is low as well, and thus the output voltage Vdd of the power supply output circuit 11 of FIG. 4 goes low. The signal S1 outputted from the dimming circuit 13A of FIG. 5 also goes low (has a duty cycle of zero percent). The current supply circuit 13B of FIG. 3 stops the supply of the drive current to the light source 20 based on the output voltage Vdd (low) of the power supply output circuit 11 and the signal S1. As a result, the light source 20 is turned off (state No. (1) in FIG. 6 and FIG. 7A).

Thus, with the turn voltage Vt alternately repeating high and low, the light source 20 intermittently lights (blinks) as a turn signal lamp, as illustrated in FIG. 7A. When the light source 20 is lit (when the turn voltage Vt is high), the disconnection detection device 100 of FIG. 3 monitors whether the input current flowing through the terminal T1 is greater than a predetermined threshold value (performs disconnection detection).

### Engine ON, Clearance Lamp Lit (ON), Turn Signal Off (OFF)

As described above, in this case, the CLL voltage Vc is high, and the clearance lamp lighting instruction signal Sc is also high. Due to the turn signal being OFF, the voltage (turn voltage Vt) applied to the terminal Ta is low.

Since the turn voltage Vt is low and the CLL voltage Vc is high, the output voltage Vdd of the power supply output circuit 11 of FIG. 4 results in a voltage corresponding to the CLL voltage Vc.

Since the turn voltage Vt is low and the clearance lamp lighting instruction signal Sc is high, the signal S1 outputted from the dimming circuit 13A of FIG. 5 results in a signal having a predetermined duty cycle (e.g., 15%). The current supply circuit 13B of FIG. 3 supplies a drive current 12 (<drive current I1) corresponding to the duty cycle to the light source 20, based on the output voltage Vdd of the power supply output circuit 11 and the signal S1, and dimly lights the light source 20 as a clearance lamp (state No. (4) in FIG. 6 and FIG. 7D). This drive current 12 corresponds to a “second current.” In this event, the turn voltage Vt is low, and thus disconnection detection by the disconnection detection device 100 is not performed.

### Engine ON, Clearance Lamp Off (OFF), Turn Signal Blinking (ON, OFF)

As described above, in this case, the CLL voltage Vc is high, and the clearance lamp lighting instruction signal Sc is low. The turn voltage Vt alternately repeats high and low at a predetermined period.

When the turn voltage Vt is high, regardless of the CLL voltage Vc, the output voltage Vdd of the power supply output circuit 11 of FIG. 4 results in a voltage corresponding to the turn voltage Vt. The signal S1 outputted from the dimming circuit 13A of FIG. 5 goes high (has a duty cycle of 100%). The current supply circuit 13B of FIG. 3 supplies the drive current 11 to the light source 20 based on the output voltage Vdd of the power supply output circuit 11 and the signal S1, and lights it as a turn signal lamp (state No. (5) in FIG. 6 and FIG. 7C).

When the turn voltage Vt is low, the CLL voltage Vc is high, and thus the output voltage Vdd of the power supply output circuit 11 of FIG. 4 results in a voltage corresponding to the CLL voltage Vc. However, since the turn voltage Vt is low and the clearance lamp lighting instruction signal Sc is low, the signal S1 outputted from the dimming circuit 13A of FIG. 5 is also low (has a duty cycle of zero percent). The current supply circuit 13B of FIG. 3 stops the supply of drive current to the light source 20 in response to the signal S1 of the low level (having a duty cycle of zero percent). As a result, the light source 20 is turned off (state No. (3) in FIG. 6 and FIG. 7C).

Thus, with the turn voltage Vt alternately repeating high and low, the light source 20 intermittently lights (blinks) as a turn signal lamp, as illustrated in FIG. 7C. When the light source 20 is lit (when the turn voltage Vt is high), the disconnection detection device 100 of FIG. 3 monitors whether the input current flowing through the terminal T1 is greater than the predetermined threshold value (performs disconnection detection).

### Engine ON, Clearance Lamp Lit (ON), Turn Signal Blinking (ON, OFF)

As described above, in this case, the CLL voltage Vc is high, and the clearance lamp lighting instruction signal Sc is high. The turn voltage Vt alternately repeats high and low at a predetermined period.

When the turn voltage Vt is high, regardless of the CLL voltage Vc, the output voltage Vdd of the power supply output circuit 11 of FIG. 4 results in a voltage corresponding to the turn voltage Vt. The signal S1 outputted from the dimming circuit 13A of FIG. 5 goes high (has a duty cycle of 100%). The current supply circuit 13B of FIG. 3 supplies the drive current 11 to the light source 20, based on the output voltage Vdd of the power supply output circuit 11 and the signal S1, and lights it as a turn signal lamp (state No. (6) in FIG. 6 and FIG. 7D). In this event, the disconnection detection device 100 monitors whether the input current flowing through the terminal T1 is greater than the predetermined threshold value (performs disconnection detection).

Note that if the light source 20 is to be lit based on the CLL voltage Vc, the input current does not flow through the terminal T1 even though the turn voltage Vt is high, and thus the disconnection detection device 100 may perform erroneous detection. In an embodiment of the present disclosure, the light source 20 is lit based on the turn voltage Vt (the turn voltage Vt is prioritized) when both the turn voltage Vt and the CLL voltage Vc are high, thereby being able to prevent erroneous detection.

When the turn voltage Vt is low, the output voltage Vdd of the power supply output circuit 11 of FIG. 4 results in a voltage corresponding to the CLL voltage Vc. Since the turn voltage Vt is low and the clearance lamp lighting instruction signal Sc is high, the signal S1 outputted from the dimming circuit 13A of FIG. 5 results in a signal having a predetermined duty cycle (e.g., 15%). The current supply circuit 13B of FIG. 3 supplies the drive current 12 (<drive current I1) corresponding to the duty cycle to the light source 20, based on the output voltage Vdd of the power supply output circuit 11 and the signal S1, and dimly lights the light source 20 as a clearance lamp (state No. (4) in FIG. 6 and FIG. 7D). Note that since the turn voltage Vt is low, disconnection detection by the disconnection detection device 100 is not performed.

Thus, as illustrated in FIG. 7D, the light source 20 is lit as a turn signal lamp when the turn voltage Vt is high, and is lit (dimly lit) as a clearance lamp when the turn voltage Vt is low.

### Summary

The lighting module 10 of an embodiment of the present disclosure has been described above. The lighting module 10 is a lighting circuit configured to light the light source 20 of the vehicular lamp 1, and includes the terminal T1 configured to receive the turn voltage Vt, the terminal T2 configured to receive the CLL voltage Vc, the power supply output circuit 11, and the driver circuit 13. The power supply output circuit 11 outputs a voltage corresponding to the turn voltage Vt regardless of whether the CLL voltage Vc is applied to the terminal T2, when the turn voltage Vt is applied to the terminal T1, and outputs a voltage corresponding to the CLL voltage Vc, when the turn voltage Vt is not applied to the terminal T1 and the CLL voltage Vc is applied to the terminal T2. The driver circuit 13 supplies the drive current 11 to the light source 20, based on that voltage, when a voltage corresponding to the turn voltage Vt is outputted from the power supply output circuit 11, and supplies the drive current 12 to the light source 20, based on that voltage, when a voltage corresponding to the CLL voltage Vc is outputted from the power supply output circuit 11. An input current used to detect a disconnection in the light source 20 flows through the terminal T1, when the turn voltage Vt is applied to the terminal T1. This makes it possible to implement two functions (the function of a turn signal lamp and the function of a clearance lamp) with the lighting module 10 (the lighting circuit) and the light source 20. Thus, a reduction in costs can be achieved.

In the states No. (2), (5), and (6) of FIGS. 7A to 7D, the disconnection detection device 100 performs disconnection detection based on the current flowing from the vehicle side (outside of the vehicular lamp 1) to the power supply line L1 (in other words, the terminal T1). This makes it possible to perform disconnection detection appropriately, and erroneous detection can be prevented.

The lighting module 10 is applied to the vehicular lamp 1, the turn voltage Vt is a voltage to light (blink) the light source 20 as a turn signal lamp, and the CLL voltage Vc is a voltage to light the light source 20 as a clearance lamp. This makes it possible to light the light source 20 as a turn signal lamp and a clearance lamp.

The power supply output circuit 11 includes the diode D1 having an anode connected to the terminal T1, the diode D2 having an anode connected to the terminal T2, the PMOS transistor Q1 connected between the cathode of the diode D2 and the cathode of the diode D1, and the switch control circuit 111. The switch control circuit 111 turns off the PMOS transistor Q1 so that a voltage corresponding to the turn voltage Vt is outputted, when the turn voltage Vt is applied to the terminal T1. Further, it turns on the PMOS transistor Q1 so that a voltage corresponding to the CLL voltage Vc is outputted, when the CLL voltage Vc is applied to the terminal T2 without the turn voltage Vt being applied to the terminal T1. This makes it possible to switch the voltage to be outputted while preventing a reverse current to the vehicle side.

The driver circuit 13 includes the dimming circuit 13A configured to output the signal S1 having a duty cycle that is based on the state of the light source 20, and the current supply circuit 13B configured to generate a current that increases with an increase in the duty cycle of the signal S1, to supply the current to the light source 20. The dimming circuit 13A outputs the signal S1 having a duty cycle of 100% (high), in the states No. (2), (5), and (6) in which the light source 20 is lit based on the turn voltage Vt; outputs the signal S1 having a duty cycle of zero (low), in the states No. (1) and (3) in which the light source 20 is off; and outputs the signal S1 having a predetermined duty cycle (e.g., 15%) smaller than a duty cycle of 100%, in the state No. (4) in which the light source 20 is lit based on the CLL voltage Vc. This makes it possible to change the lighting/turning off and the brightness of the light source 20 according to the duty cycle.

The vehicular lamp 1 of an embodiment of the present disclosure can implement two functions (the functions of a turn signal lamp and a clearance lamp) by the lighting module 10 and the light source 20.

Embodiment(s) of the present disclosure described above is/are simply to facilitate understanding of the present disclosure and is/are not in any way to be construed as limiting the present disclosure. The present disclosure may variously be changed or altered without departing from its essential features and encompass equivalents thereof.

Although the vehicular lamp 1 of an embodiment described above shares a turn signal lamp and a clearance lamp, the present disclosure is not limited thereto. For example, it can also be applied to a tail lamp and a brake lamp (stop lamp) as well.

In an embodiment described above, the plurality of light-emitting elements (LEDs) are connected in series in the light source 20, but the present disclosure is not limited thereto. For example, a plurality of light-emitting elements may be connected in parallel. Further, the number of light-emitting elements may be one.

### REFERENCE SIGNS LIST

1, 1A Vehicular lamp
10 Lighting module
11 Power supply output circuit
13 Driver circuit
13A Dimming circuit
13B Current supply circuit
15 Control IC
20, 20A, 20B Light source
31 turn signal lighting circuit
32 clearance lamp lighting circuit
33 Dimming circuit
100 disconnection detection device
111 switch control circuit
131 oscillator circuit
151 power supply circuit
C1, C2 Capacitor
T1 to T5, Ta to Tg Terminal
L1, L2 Power supply line
OP1 Operational amplifier
Q1 PMOS transistor
Q2, Q4, Q5, Q7 NPN transistor
Q3, Q6 PNP transistor
R1 to R14 Resistor
Vt Turn power supply voltage (turn voltage)
Vc Clearance power supply voltage (CLL voltage)
Vcc Power supply voltage
Sc Clearance lamp lighting instruction signal

1. A lighting circuit configured to light a light source, the lighting circuit comprising:
a first terminal configured to receive a first power supply voltage;
a second terminal configured to receive a second power supply voltage;
a power supply output circuit configured to
output a first voltage corresponding to the first power supply voltage, regardless of whether the second power supply voltage is applied to the second terminal, when the first power supply voltage is applied to the first terminal, and
output a second voltage corresponding to the second power supply voltage, when the second power supply voltage is applied to the second terminal without the first power supply voltage being applied to the first terminal; and
a driver circuit configured to
supply a first current to the light source, based on the first voltage, when the first voltage is outputted from the power supply output circuit, and
supply a second current to the light source, based on the second voltage, when the second voltage is outputted from the power supply output circuit,
wherein an input current used to detect a disconnection in the light source flows through the first terminal, when the first power supply voltage is applied to the first terminal.

2. The lighting circuit according to claim 1, wherein
a current value of the first current is greater than a current value of the second current.

3. The lighting circuit according to claim 1, wherein
the power supply output circuit includes
a first diode having an anode connected to the first terminal,
a second diode having an anode connected to the second terminal,
a switch connected between a cathode of the second diode and a cathode of the first diode, and
a switch control circuit configured to
turn off the switch so that the first voltage is outputted, when the first power supply voltage is applied to the first terminal, and
turn on the switch so that the second voltage is outputted, when the second power supply voltage is applied to the second terminal without the first power supply voltage being applied to the first terminal.

4. The lighting circuit according to claim 1, wherein
the driver circuit includes
a dimming circuit configured to output a signal having a duty cycle that is based on a state of the light source, and
a current supply circuit configured to generate a current that increases with an increase in the duty cycle, to supply the current to the light source, and
the dimming circuit is configured to
in a first state in which the light source is lit based on the first power supply voltage, output the signal having a first duty cycle,
in a second state in which the light source is off, output the signal having the duty cycle of zero, and
in a third state in which the light source is lit based on the second power supply voltage, output the signal having a second duty cycle that is smaller than the first duty cycle.

5. The lighting circuit according to claim 1 applied to a vehicular lamp, wherein
the first power supply voltage is a voltage to light the light source as a turn signal lamp, and
the second power supply voltage is a voltage to light the light source as a clearance lamp.

6. A vehicular lamp comprising:
the lighting circuit according to claim 1; and
the light source.

7. A vehicular lamp comprising:
the lighting circuit according to claim 2; and
the light source.

8. A vehicular lamp comprising:
the lighting circuit according to claim 3; and
the light source.

9. A vehicular lamp comprising:
the lighting circuit according to claim 4; and
the light source.

10. A vehicular lamp comprising:
the lighting circuit according to claim 5; and
the light source.
